(19) United States
(12) Patent Application Publication
(10) Pub. No.: US 2004/0135386 A1
(43) Pub. Date: Jul. 15, 2004

(54) Animal waste picker

(76) Inventor: Horacio Dizon Pineda, New York, NY (US)

Correspondence Address: HORACIO D. PINEDA, APT. 2710, 320 EAST 42 ST., NEW YORK, NY, 10017, US

(21) Appl. No.: 10/340,807

(22) Filed: Jan. 13, 2003

(51) Int. Cl. A01K 29/00; E01H 1/12

(52) U.S. Cl. 294/1.4

(57) ABSTRACT

This is an improved, method of gathering, bagging and disposing solid animal waste based on the principle of a noose or purse string. The device is a long tubular housing equipped with a collecting bag on its far end, which is held open by radially arranged projections. The bag opening is encircled by a loop of string arranged in purse string fashion. When filled, the bag can be closed by triggering a spring-loaded retractable rod connected to the loop of string by a closable hook, after it passes through a fixed eyelet hole. The filled bag can be disposed of in any appropriate receptacle by opening the hook, which releases the string, the closed bag and its contents. This device is practical, sanitary, and allows one-handed operation.

### BACKGROUND OF THE INVENTION

Most localities in the United States mandate appropriate disposal of solid animal waste. A device that can help pet owners dispose of their pets waste easily and cleanly is sorely needed particularly in urban areas. A device that is small, portable, sanitary to operate, and easily operated with one hand is highly desirable. Many devices addressing this problem had been invented. These devices include scoopers, rakes, and baggers. Frank Ockerman's scooper, U.S. Pat. No. 5,718,469, for example, consists of a support hoop with a handle and disposable wastebag. Irving Ring, U.S. Pat. No. 5,741,036, presents a scooper with a shovel portion comprising of fingerlike projections that are fitted with a glovelike disposable bag. Still,Sominski et al, U.S. Pat. No. 6,086,123 shows a pair of arms fitted with a disposable bag and operated by a squeeze handle. Although these inventions represent significant improvements from older inventions, their operation remain complicated and unwieldy thus making them impractical. The present invention offers portability, ease of use, one handed operation and a sanitary way of waste disposal.

### SUMMARY OF THE INVENTION

The object of this invention is to provide an improved sanitary, portable, and practical means of animal solid waste collection and disposal. This invention applies the principle of purse string. Drawing the string tightly can close a plastic bag with a loop of string either placed or stitched around its neck. The plastic bag is held open by means of radially arranged wire spokes wherein it is suspended upside down with its open end serving as the base, much like a canvas tent held up by poles. The loop of string surrounding the bag's neck is passed through a stationary hole at the end of a metal piece. Just beyond the hole, the drawstring is attached on to a closable hook, which is connected, to a retractable rod. The radially arranged wire spokes, the inverted plastic bag, the metal piece with a fixed hole and the closable hooked end of the retractable rod are all mounted on one end of a hollow tube by an end base which anchors the fixed structures and is equipped with a hole to allow the retractable rod (with a hook) to slide within. The hollow tube is equipped with a sliding hood designed to cover the end pieces when the instrument is not in use.

Within the tube, the end of the retractable hooked rod is connected to a spring or bungee cord, which tends to pull the rod in. A latch mechanism connected to a trigger button is designed to hold the retractable hooked rod in the extended or cocked position.

Operation of the instrument begins by retracting the protective hood and gathering the animal waste matter within the bag. Pressing the trigger button releases the cocked retractable rod which consequently pulls the loop of string against the stationary hole effectively closing the bag much like pulling the drawstrings of a pouch. The bagged waste matter can be released onto an appropriate garbage container by releasing the cord from the hook.

### BRIEF DESCRIPTION OF THE DRAWINGS

FIG. 1 is a perspective of the device without the plastic bag but showing the different external parts. FIGS. 1a and 1b shows the hood retracted and extended respectively.

FIG. 2 shows a partial cross section showing the internal and external parts in the assembled positions.

FIG. 3 shows the individual parts disassembled.

FIG. 4 shows the process of fitting the bag and string onto the device.

FIG. 5 illustrates how the device operates.

### DETAILED DESCRIPTION OF THE INVENTION

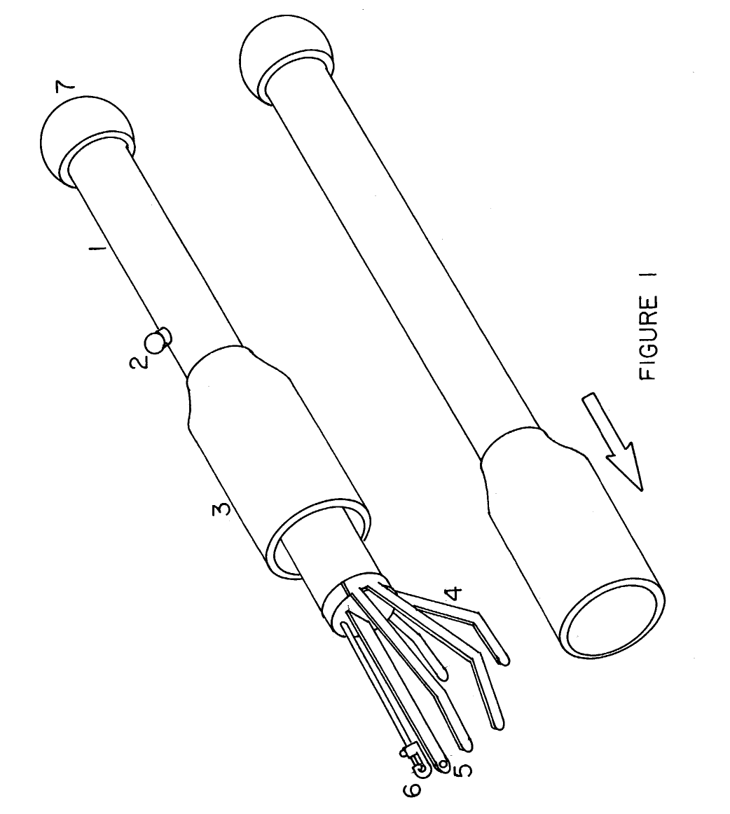

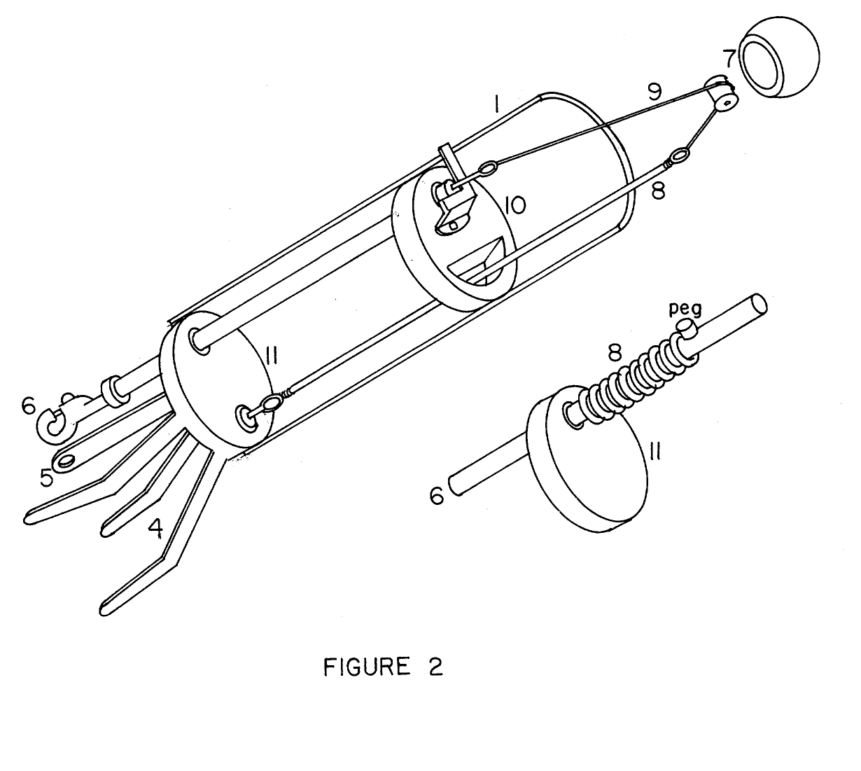

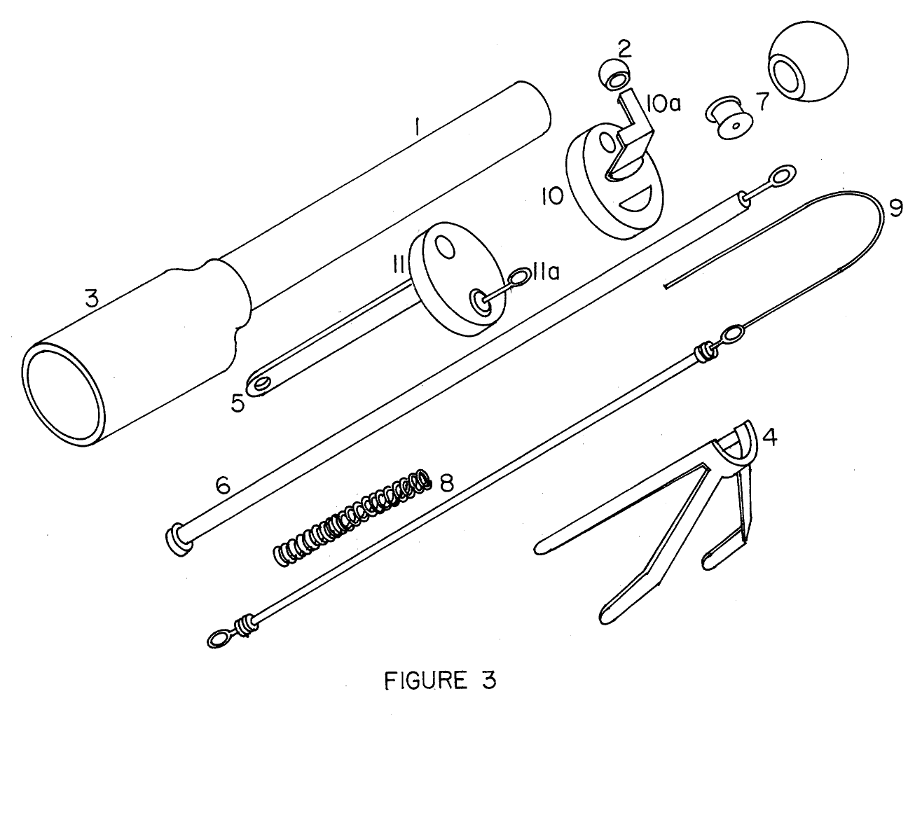

(FIG. 1) The device is a long tubular casing (1) equipped with a sliding hood (3). Retracting the hood reveals a basket (4) made up of four or five wire or plastic projections arranged radially from the far end of the tubular casing. A circular end base (11 FIG. 2 and FIG. 3) acts a s a distal plug to the tube as well as a base of attachment for the basket projections (4) and a long flat metal rod with a hole punched near its far end (5). The end base (11) also has a round hole through which a long rod with a terminal closable hook (6) passes. Within the tubular casing (1 FIG. 2), the rod with the distal hook passes through a hole in the inner base (10). This inner base serves as a platform to anchor a metal latch (10a FIG. 3) designed to catch and hold the proximal end of the hooked rod (6). The metal latch has one fixed end on the inner base (10) and a movable end, which passes through a slit on the side of the tubular casing. Outside the casing, a trigger button (2) is attached to the protruding end of the metal latch. Inside the tubular casing, the hooked rod (6) is connected to a spring or bungee cord (3) by a wire (9) which loops around a pulley wheel attached to the end cap (7). The other end of the spring or bungee cord is anchored to the end base (11,11a). Alternatively; the same effect can be achieved by enclosing the shaft of the movable rod (6) with a spring (8 FIG. 2) which is resting on one end on the end base (11) and the other end provided with a peg drilled through the rod shaft (FIG. 2).

### METHOD OF OPERATION

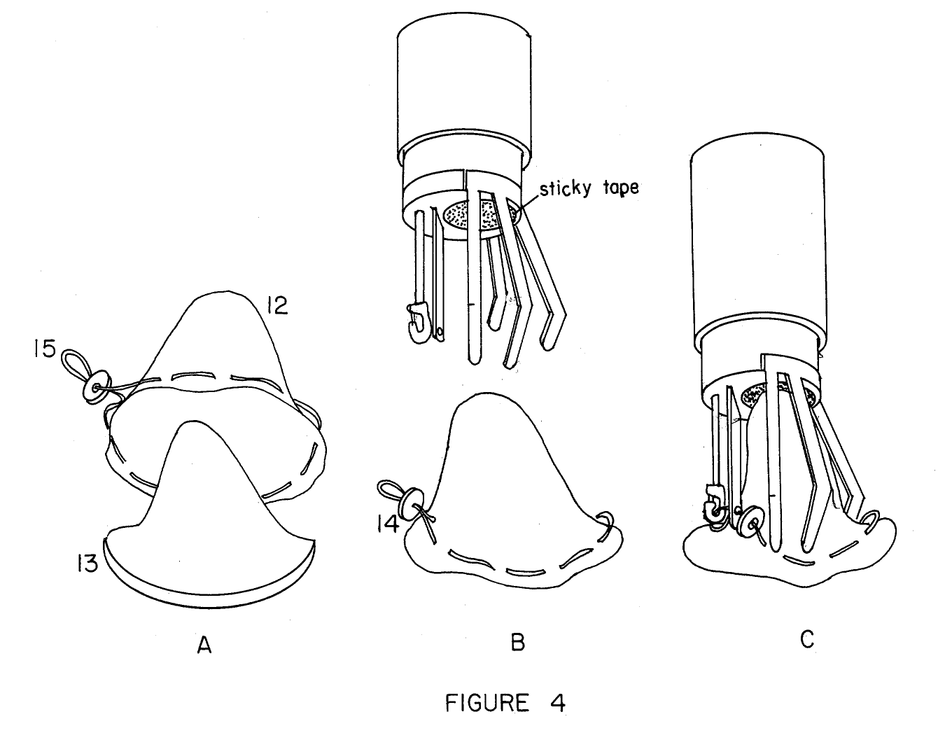

Loading the plastic bag onto the device (FIG. 4) can be done by hand but using a mould can facilitate the process. A plastic bag (12) with a loop of string (15) either stitched on or just placed around the opening of the bag is fitted onto a plastic mould (13). The free end of the bag opening is made to hang over the edge of the mould but the loop of string must rest on the collar of the mould (FIG. 4b).

Engage the hooked rod (6) by pulling the hook down until latch (10a) catches and holds the rod in the cocked or ready position. Place the basket (4) over the bag on the mould (FIG. 4c), making sure the tips of the basket projections are resting on the collar of the mould where the loop of string is resting. Insert the end of the string loop through the hole of the fixed rod (5) and then connect the end to the hook (FIG. 4c). Fold the edge of the plastic bag over the tips of the basket projections and gently pull the device and the plastic bag off the mould. The plastic bag should stay within the basket since the apex of the bag should stick to a sticky tape placed beneath the end base (11).

To set the device for transport, fold the projections of the basket and the plastic bag inwards like folding an umbrella. Gently slide the hood (3) cover, making sure the folded edges of the bag are tucked within the hood (FIG. 1b). The device can now-be carried around, ready to use when needed.

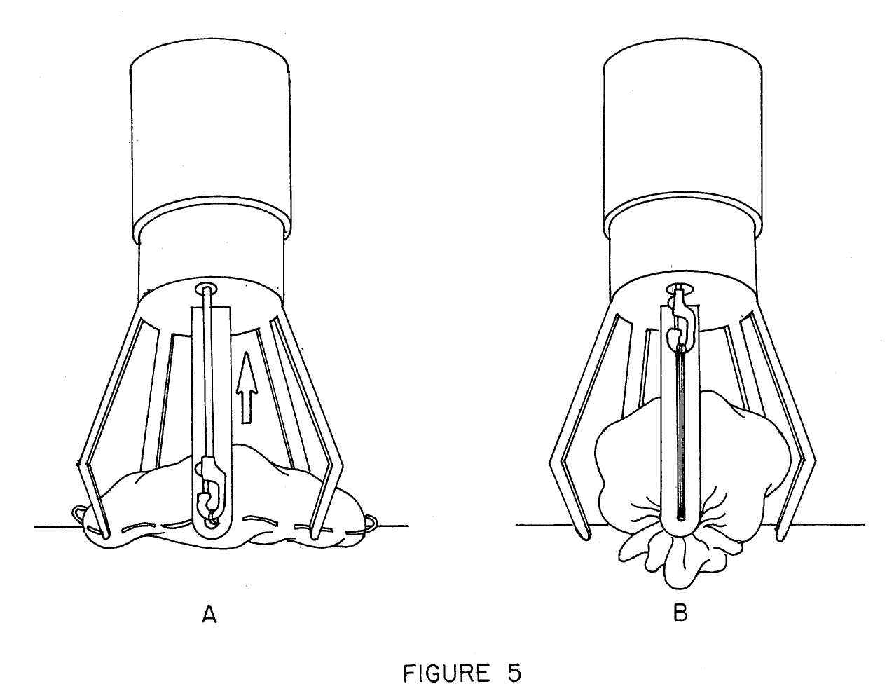

To use the device, gently retract the hood back. Gather all the pieces of animal waste inside the plastic bag within the basket (FIG. 5a). With the tips of the basket projections resting on the ground, press the trigger button (2). Within the tubular casing, the latch releases the end of the hooked rod (6) to be pulled in by the spring or bungee cord (8). Outside the casing, the hook holding the looped string retracts. Since the loop of string surrounds the neck of the plastic bag, pulling the string through the hole of the stationary rod (5) draws the opening of the bag closed like a noose (FIG. 5b). The bag and its contents can now be taken to-an appropriate receptacle. To release the bag and its contents, slide open the hook and the end of the looped string will release—causing the bag to fall off.

I claim:

1. An improved, sanitary, one hand operated instrument for gathering, bagging and disposing of solid animal waste, comprising of: a long tube equipped with a collecting bag attached to one end that is provided with a closed loop of string arranged in pursed string fashion near the bag opening, which serves to close the bag when it is drawn through an eyelet hole when a spring loaded rod to which it is connected is triggered.

2. The sanitary instrument for gathering, bagging and disposing of solid animal waste in claim 1, further comprising of an end base made up of a flat circular piece of wood, metal or plastic, fixed to the distal end of the tubular housing, is provided with a hole to accommodate passage of the movable hooked rod and also serves as a base of attachment for the fixed rod with the eyelet hole, and as an anchor for the spring or bungee cord.

3. The sanitary instrument for gathering, bagging and disposing of solid animal waste in claim 1, further comprising of a flat inner base fixed inside the tubular housing, made out of wood, plastic or metal, which is designed to anchor the base of the latch trigger and also serves to guide the sliding movement of the movable rod through a circular hole cut out.

4. The sanitary instrument for gathering, bagging, and disposing of solid animal waste in claim 1, further comprising of a basket made up of springy metal or plastic rods arranged radially about a center point which is connected to the distal end of the tubular house which serves to hold and spread open the collecting bag.

5. The sanitary instrument for gathering, bagging, and disposing of solid animal waste in claim 1, further comprising of a flat, elongated metal rod provided with an eyelet hole at its far end, fixed to the distal end of the tubular housing by a circular end base described in claim 2, allows the loop of string encircling the mouth of the opened bag to be threaded through to form a noose.

6. The sanitary instrument for gathering, bagging and disposing of solid animal waste in claim 1, further comprising of a spring loaded movable rod equipped with a metal hook at its distal end to catch the loop of string of the collecting bag, is inserted into the tubular housing through holes provided in the end base and the inner base, which when triggered, effectively closes the collecting bag by pulling the purse string attached to it.

7. The sanitary instrument for gathering, bagging and disposing of solid animal waste in claim 1, further comprising of a spring or bungee cord located within the tubular housing, fixed on one end to an anchor attached to the inner surface of the end base, while its free end is connected to the movable rod via a wire looped around a pulley equipped end cap, provides the power to pull the movable hooked rod inward after a latch is released by pressing the trigger to which it is connected. An alternative way of powering the movable rod is to wrap a spring around the rod shaft with one end of the spring anchored to the inner side of the circular end base, while the other end rest on a peg stop drilled through the shaft of the movable rod.

8. A slidable conical hood outside the tubular housing in claim 1, is designed to cover and protect the collecting bag assembly during transport.

9. A conical mould made of plastic, metal or wood is designed to facilitate mounting of the collecting bag onto the basket.
